(19) United States
(12) Patent Application Publication
(10) Pub. No.: US 2002/0076525 A1
(43) Pub. Date: Jun. 20, 2002

(54) Method of processing bitumen-polymer blends of improved quality

(75) Inventors: Fred A. Fensel, Cleveland, OH (US); Daniel Lamar Healy, Columbia Station, OH (US); Michael Edward Klammer, Elyria, OH (US)

Correspondence Address: HAHN LOESER & PARKS, LLP, TWIN OAKS ESTATE, 1225 W. MARKET STREET, AKRON, OH, 44313, US

(73) Assignee: The Garland Company Inc.

(21) Appl. No.: 09/898,358

(22) Filed: Jul. 3, 2001

Related U.S. Application Data
(60) Provisional application No. 60/257,243, filed on Dec. 20, 2000.

(51) Int. Cl. B32B 1/00

(52) U.S. Cl. 428/150; 428/143; 428/489

(57) ABSTRACT

A roofing membrane which exhibits improved properties, particularly reduced propensity to blister, is produced by selecting a the group consisting of straight run asphalts with a rod & ball softening point in the range of from 80 to 130 degrees F.; oxidized asphalts, solvent washed asphalts, road tars, refined tars, and blends thereof; selecting a modifying polymer from a group consisting of: styrene-butadiene-styrene (“SBS”) block co-polymer, atactic polypropylene (“APP”), and a combination of SBS and APP; modifying the bitumen by adding the polymer while the bitumen is in a molten state in a sealed mixing vessel; exposing the modified bitumen to a pressure less than ambient during or after modification while still in a molten state to allow release of entrained gases; and forming the roofing membrane from the molten modified bitumen.

The present invention relates to a method of processing bitumen-polymer blends, used in producing modified bituminous membranes of improved quality. Extremely rapid dissolution of polymer into the bitumen is achieved with improved dispersion and minimal air void entrainment. This blend of improved process quality maximizes the waterproofing capability and performance longevity of the resulting coated modified bituminous membrane. Also provided are unique compositions of polymer-asphalt blends with secondary polymer modifiers for membranes that exhibit exemplary heat stability, toughness, flexibility, and rubber like properties.

### BACKGROUND OF THE INVENTION

Asphalt is commonly used to coat fleece or mat like materials to produce membranes or sheet materials that are impervious to water. These membranes or sheet materials are supplied in roll form and are referred as Roll Roofing or Cap Sheets. In a precut form, they are referred to as shingles. The asphalt coating typically contains inorganic filler material to plasticize and extend the asphalt, which has been air blown or oxidized to a predetermined level to prevent flow and deformation from the effects of heat, gravity, foot traffic, etc. in its roof top application. The upper surface typically contains a ceramic coated roofing granule that serves as a weathering and wearing course while the lower surface contains a inorganic mineral material as a parting and anti-stick material agent.

These types of asphalt coatings are modified with polymers because unmodified air-blown asphalt coatings are brittle, inflexible, and lack strength and durability. The sheet or membrane materials they produce are likewise brittle in nature, often cracking during application. A polymer-modified asphalt coating becomes flexible, has added strength and durability, and also has improved temperature susceptibility. Poor temperature susceptibility for asphalt is defined as having poor physical properties at the low and high ends of the temperature range of actual field use or performance. At cold temperatures, asphalt becomes glassy, brittles, and breaks easily. At high temperatures, the asphalt becomes soft, flows and deforms—all under actual use conditions. Polymer modification with styrene-butadiene-styrene {“SBS”} block co-polymer or atactic polypropylene(APP) improves the low temperature susceptibility. Such an asphalt-polymer blend remains flexible, becomes plastic/elastic and durable. Further, at high temperatures, the asphalt-polymer blend has a higher softening point, higher melting point, and better sag and flow resistance resisting deformation. These types of polymer-modified asphalt coatings are used to coat fleece or mat like reinforcement materials producing Roll Roofing materials called Modified Bituminous Membranes.

Typical recipes for SBS-asphalt blends consist of thermoplastic block copolymers at 5 to 20 percent by weight, similar to and including, the Kraton D1101, D1184 types, or, of the Phillips Solprene 411 types sold under the EUROPRENE, FINAPRENE, and CALPRENE labels. Typical APP recipes include amorphous polypropylenes or atactic polypropylene at loadings of 15 to 30 percent by weight with an optional amount of crystalline or isotactic polypropylenes(IPP) at loadings of 0 to 5 percent. Examples of APP are Eastman Chemical's ELASTOFLEX M-5H or Huls VESTOPLAST 891. An example of IPP is Iscom's IC-20. In these recipes, the SBS and the APP are primary asphalt modifiers. Prior art formulations do not use secondary polymers to enhance the aging of these polymer asphalt blends.

Polymer modified asphalt coatings are usually treated at temperatures in the range of from about 300 to about 400 degrees F, to assure that the components are in a fluid state. SBS is typically added in a solid form, although APP may be added in either liquid or solid form, to the molten liquid asphalt. The materials are mixed under heat and agitation until a homogenous blend is achieved. As the polymer disperses within the asphalt under mixing or agitation, the viscosity of the blend increases dramatically. In a manner not unlike that encountered in many kitchen methods, the increase in viscosity under agitation causes entrainment of air as part of the mixing operation. The high viscosity does not allow release of the air, so the modified asphalt has entrained air as the material is moved to the coating operation of the fleece or mat like material. Air voids or pockets, on the order of around 100 to 1000 microns, are formed in the modified bituminous membrane sheet material. The entrapped air causes loss of performance in the modified bituminous membranes. They also cause blisters in the sheet material in field performance. As the air heats or warms up from the heat of sun, it expands, putting the pocket under positive pressure, forming a blister. The constant cycling of expansion and contraction from heating that occurs from the sun during the day and cooling that occurs during the night causes premature physical wear and stress. As a result, the product fails prematurely, causing a breach in the waterproofing integrity of the membrane. These breaches cause even further deteriorate the roof assembly, by allowing water to penetrate the individual components of the roof assembly, where it can freeze and thaw, causing even further damage. Also, some of the larger air voids or pockets can cause incomplete coating and sealing of the reinforcement, creating a direct channel allowing water to penetrate and wick into the fleece/mat reinforcement. Once water penetrates into the fleece or mat material, it spreads, causing delamination of the polymer asphalt coating and widespread material failure.

The prior art has not taught a process for preventing or minimizing air entrainment in the modified asphalt polymer blend.

### SUMMARY OF THE INVENTION

This and other advantages of the present invention are achieved by producing a roofing membrane comprising a continuous matrix of bitumen modified by addition of a polymer, the matrix being characterized as being substantially free of voids containing entrained air.

In some embodiments, the modifying polymer is selected from a group consisting of: styrene-butadiene-styrene (“SBS”) block co-polymer, atactic polypropylene (“APP”), and a combination of SBS and APP.

In some embodiments, the bitumen is selected from the group consisting of straight run asphalts with a rod & ball softening point in the range of from 80 to 130 degrees F.; oxidized asphalts, solvent washed asphalts, road tars, refined tars, and blends thereof.

In some aspects of the invention, the bitumen is modified by the polymer by adding the polymer to the bitumen while the bitumen is in a molten state in a sealed mixing vessel at a pressure inside the vessel of less than ambient. In other useful aspects of the invention, the bitumen is modified by the polymer by adding the polymer to the bitumen while the bitumen is in a molten state until the polymer is completely dispersed in the bitumen, followed by residence of the modified bitumen in a sealed vessel at a pressure inside the vessel of less than ambient. In either of these cases, the internal pressure in the vessel is at least 15 inches Mercury less than ambient.

In many aspects of the invention, the modified bitumen continuous matrix embeds a reinforcing mat of fibers. In many aspects, an upper or weathering surface of the membrane is coated with a granular material, particularly a No. 11 ceramic roofing granule. In some embodiments, a lower or non-weathering surface of the membrane is coated with a means for preventing self-adhesion, especially wherein the means for preventing self-adhesion is a fine silica sand.

The modifying polymer is present in the modified bitumen in the range of from about 5 to about 30 percent by weight.

In many cases, the bitumen is further modified by a secondary modifying polymer selected from the group consisting of styrene-isoprene styrene (“SIS”), styreneethylene-butylene-styrene (“SEBS”), styrene-ethylene (“SE”) and combinations thereof.

The modifying polymer is typically added to the bitumen while the bitumen is agitated in a mixer at a temperature in the range of from about 300 to about 400 degrees Fahrenheit.

In a roofing membrane of the present invention, the roofing membrane exhibits no blistering from entrained air voids after being submerged in water at about 120 degrees F. for 72 hours, then maintained at about 160 degrees F. under at least 15 in. Hg vacuum for up to 48 hours.

### BRIEF DESCRIPTION OF THE DRAWINGS

The present invention will be best understood when reference is made to the detailed description of the invention and the accompanying drawings, wherein identical parts are identified by identical reference numbers, and wherein:

FIG. 1 shows a side sectional view of a modified bituminous membrane as known in the prior art; and

FIG. 2 shows a side sectional view of a modified bituminous membrane according to the present invention.

### DETAILED DESCRIPTION OF THE PREFERRED EMBODIMENT

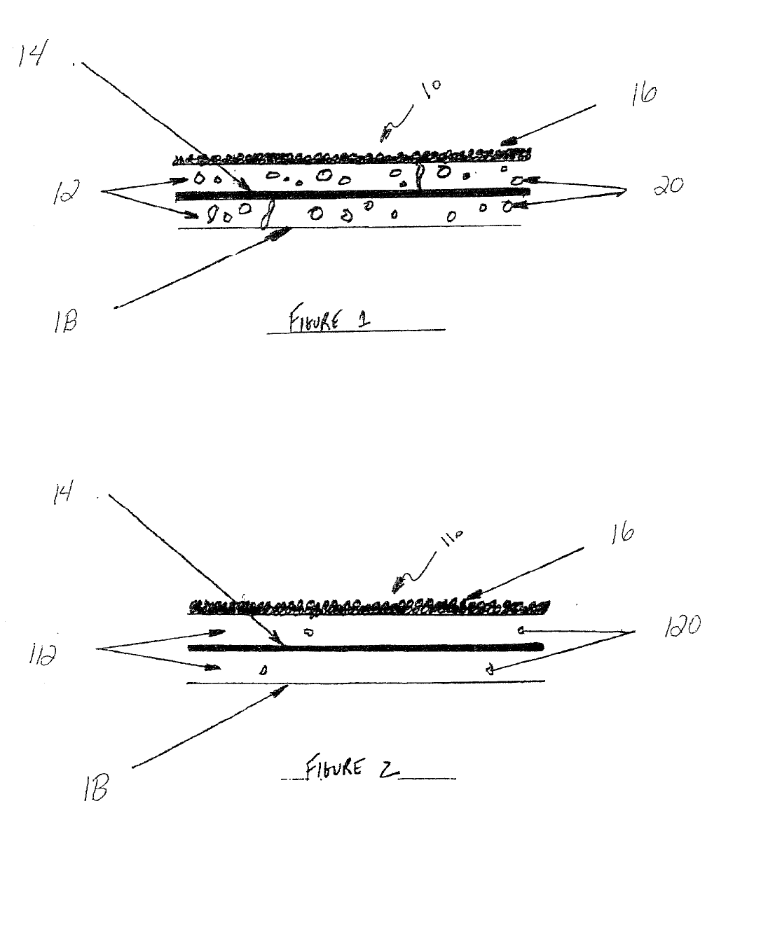

The present invention will be best understood by reference to FIGS. 1 and 2. A modified bituminous membrane 10 as known in the prior art is a sheet material comprising a polymer-asphalt blend 12 saturating or forming a continuous matrix that embeds a fleece or mat like reinforcing inner core 14. The primary modifiers of the bitumen are SBS and APP. An upper surface or weathering surface of the membrane 10 is typically coated with a ceramic granular material 16. One such material 16 is sold commercially as No. 11 Roofing Granule. A bottom surface of the membrane typically is coated with a means 18 to prevent sticking or adhesion, especially self-adhesion. One commonly-used means is a fine silica sand. Because of the agitation involved in normal processing of the asphalt polymer blend, air is inherently entrained or entrapped during the mixing process or the dispersion of the polymer in the bitumen matrix. This entrained air results in the creation of air voids 20 in the polymer-asphalt matrix 12. These voids 20 adversely affect the performance properties of the membrane 10. In a typical membrane 10 of the prior art, voids 20 comprise a small but measurable amount of the volume of the membrane. This amount of voidage may be estimated through a directly measurable decrease in membrane density.

The present invention produces a modified bituminous membrane 110 which is previously unknown in the prior art. Like the prior art membrane 10, it comprises a polymer-asphalt blend 112 saturating or forming a continuous matrix that embeds the fleece or mat like reinforcing inner core 14. The polymer-asphalt blend 112 is substantially the same composition as the blend 12 of the prior art, but is distinctly different in physical properties due to the difference in the voidage. The upper or weathering surface of the membrane 10 is typically coated with the ceramic granular material 16. The bottom surface of the membrane typically is coated with the means 18 for preventing sticking or adhesion, especially self-adhesion. The difference between the prior art membrane 10 and the membrane 110 of the present invention is the amount and dispersion of the voids 120. By dispersing the polymer in the asphalt at a pressure lower than atmospheric, entrained air is reduced or eliminated. By measuring membrane density, the polymer-asphalt blend is observed to have a density which is in the range of 5 to 8% higher when the blend is processed at pressures less than atmospheric. In particular, this level of increase is observed when the processing is conducted at a pressure at least 15 in. Hg lower than atmospheric. As a result, the volumetric portion of the membrane comprising voids is reduced, by reducing either the average size of voids, the average number of voids per unit volume of membrane or both. As a result, the membrane 110 behaves more like a truly continuous matrix of the polymer-asphalt blend than the membrane 10 of the prior art.

Typical SBS asphalt recipes consist of thermoplastic block copolymers at 5 to 20 percent by weight similar to and including the Kraton types or of the Phillips Solprene types sold under Europrene, Finaprene, Calprene labels. Typical APP recipes include amorphous polypropylenes or attactic polypropylene at loadings of 15 to 30 percent by weight with optional amount of crystalline or isotactic polypropylenes at loadings of 0 to 5 percent. Examples of APP are Eastman Chemical's Elastoflex M-5H or Huls Vestoplast 891 while examples of IPP are Iscom's IC-20.

In these recipes the SBS and the APP are primary asphalt modifiers, the modifiers that are used to give the polymer asphalt blend it's improved low temperature properties—flexibility, plastic/elastic properties, strength, durability; and, it's improved high temperature properties—high softening point, reduced flow and improved sag/deformation resistance. What has been found and is an object of this invention is the use of secondary polymers to enhance the aging of these polymer asphalt blends. Specifically claimed is StyreneIsoprene-Styrene(SIS), Styrene-Ethylene-Butlyene-Styrene(SEBS), and Styrene-Ethylene(SE) thermoplastic block co-polymers. These polymers, either used by themselves or in conjunction with one another enhance the typical aging characteristics of polymer asphalt blends. These secondary modifiers enhance the properties of the primary polymer asphalt blends by two different distinct mechanisms depending upon the polymer type. SIS's primary mode of degradation with age that occurs is chain scission, that is as it ages the polymer molecule becomes smaller in size and act as a plasticizer/softener for the SBS or APP polymer asphalt blends that becomes brittles with time as it ages losing flexibility and elasticity. SEBS and SE polymers have a hydrogenated polymer backbone that resists degradation, either chain scission or crosslinking(recombination). Withstanding any form of degradation these hydrogenated polymers retain their original properties that contribute to the physical properties of the overall polymer asphalt blend, i.e. flexibility, elasticity, and rubber like properties.

In processing of polymer modified asphalt coatings, the temperature is usually between 300 and 400 degrees F. to ensure that the components are in a fluid state. The polymer is added in solid form for the case of SBS and in either liquid or solid form for APP to the molten liquid asphalt. The materials are then mixed under heat and agitation until a homogenous blend is achieved. As the polymer disperses within the asphalt under mixing or agitation—the blend increases in viscosity. As the blend mixes with this increase in viscosity, the blend incorporates and entrains air as part of the mixing operation. Often because these blends are so high in viscosity, the air entrained in mixing does not release by itself and transfers to the coating operation of the fleece or mat like material. Air voids or pockets, on the order of around 100 to 1000 microns are formed in the modified bituminous membrane sheet material. These voids or air pockets sacrifice performance of the modified bituminous membranes. These voids or air pockets can cause blisters in the sheet material in field performance. As the air heats or warms up from the heat of sun—it expands putting the pocket under positive pressure forming a blister. Under constant cycling of expansion and contraction from heating that occurs from the sun during the day and cooling that occurs during the night—these pockets or voids undergo excessive physical wear and stress and as a result, fail prematurely causing a break in the water-proofing integrity of the membrane. These breaks in the waterproofing integrity cause the further deterioration of the roof assembly by allowing water to penetrate the individual components of the roof assembly causing even further damage. Also, larger air voids or pockets can cause incomplete coating and sealing of the reinforcement creating a direct channel allowing water to penetrate and wick into the fleece/mat reinforcement. Once water penetrates into the fleece/mat material it eventually spreads causing delamination of the polymer asphalt coating and widespread material failure.

Laboratory test methods can assess the amount of air voidage, as well as how it correlates to blistering of the modified bituminous membrane. One method of assessment is to form a specimen, typically a square specimen with 6-inch sides, cut from a piece of the formed membrane. The cut edges of the sides are sealed with asphalt to minimize edge effects, particularly lateral migration.. The specimen is immersed in water for 72 hours at a temperature of about 120 degrees F. Porosity in the specimen, especially porosity due to air voidage, allows water to displace air during this immersion. The specimens are transferred immediately to a vacuum oven and maintained at a temperature in the range of about 160 degrees F. with a vacuum in the range of from about 15 to about 25 inches Hg for up to about 48 hours. Blistering from the evaporative release of the water in the pores is directly observable if present. This laboratory blistering may be directly related to a propensity for the same specimen to blister under actual field conditions. The laboratory blistering, if it is to occur, will generally be observed within 48 hours, although many of the cases will exhibit blistering much more quickly, if it is to occur at all.

While the above describes a specific “pass/fail” test for determining the removal of air voidage from a modified bituminous membrane, it should also be observed that there are also other manners of conducting the determination. For example, in some cases, merely cutting the membrane to form the specimen and observing the matrix of the membrane for visible voidage will be a good predictor of field blistering.

The present invention teaches that, by applying vacuum or negative pressure in the mixing process, air void formation can be minimized or eliminated. By eliminating and reducing the potential for air void or pocket formation the long term performance of the modified bituminous sheet material can be greatly improved. A preferred mixing unit is the VERSIMIX manufactured by Charles Ross & Sons or equivalent. This unit allows for rapid dissolution of polymer into asphalt to which vacuum or negative pressure can be applied. The mixing unit has three type of mix heads: a mixer/emulsifier head providing high shear and particle size reduction; a high speed disperser head similar to a Cowles type mixer for dispersing solid powder particulate; and, a low speed sweep to keep material moving and flowing over itself. This type of mixing is unique to polymer-asphalt technology, even more so when combined application of vacuum. Polymer asphalt blends are mixed to complete dispersion with filler addition in 30 to 45 minutes, typical vacuum stages are applied for 5 to 15 minutes after dispersion is complete at 15 to 25 inches Hg negative pressure. Typical mixing times for polymer asphalt blends on conventional equipment is two to twenty four hours.

While a process for applying the deaerating vacuum during the modification of the bitumen with polymer has described in detail, the invention is not limited to only that particular process. Specifically, the polymer modification of the bitumen greatly increases viscosity, which also increases the entrainment of air during mixing. The critical aspect of the invention, as viewed by the inventors, is that the bitumen, once modified to increase the viscosity, should be allowed to release any entrained air through a vacuum treatment before being formed into the membrane and certainly after any vigorous mixing procedure. The deaeration procedure may be at the end of the blending step in the same vessel, it may be in a separate vessel after the blending step and it may even be achieved using in-line deaeration techniques while pumping the modified bitumen at the point of forming the membrane.

What is claimed is:

1. A roofing membrane, comprising:
a continuous matrix of bitumen modified by addition of a polymer, the matrix being characterized as being substantially free of voids containing entrained air.

2. The roofing membrane of claim 1, wherein the modifying polymer is selected from a group consisting of: styrene-butadiene-styrene (“SBS”) block co-polymer, atactic polypropylene (“APP”), and a combination of SBS and APP.

3. The roofing membrane of claim 1, wherein the bitumen is selected from the group consisting of straight run asphalts with a rod & ball softening point in the range of from 80 to 130 degrees F.; oxidized asphalts, solvent washed asphalts, road tars, refined tars, and blends thereof.

4. The roofing membrane of claim 1, wherein the bitumen is modified by the polymer by adding the polymer to the bitumen while the bitumen is in a molten state in a sealed mixing vessel at a pressure inside the vessel of less than ambient.

5. The roofing membrane of claim 1, wherein the bitumen is modified by the polymer by adding the polymer to the bitumen while the bitumen is in a molten state until the polymer is completely dispersed in the bitumen, followed by residence of the modified bitumen in a sealed vessel at a pressure inside the vessel of less than ambient.

6. The roofing membrane of claim 4 wherein the internal pressure in the vessel is at least 15 inches Mercury less than ambient.

7. The roofing membrane of claim 5 wherein the internal pressure in the vessel is at least 15 inches Mercury less than ambient.

8. The roofing membrane of claim 1, wherein the modified bitumen continuous matrix embeds a reinforcing mat of fibers.

9. The roofing membrane of claim 1, wherein an upper or weathering surface of the membrane is coated with a granular material.

10. The roofing membrane of claim 9, wherein the granular material is a No. 11 ceramic roofing granule.

11. The roofing membrane of claim 1, wherein a lower or non-weathering surface of the membrane is coated with a means for preventing self-adhesion.

12. The roofing membrane of claim 11, wherein the means for preventing self-adhesion is a fine silica sand.

13. The roofing membrane of claim 1, wherein the modifying polymer is present in the modified bitumen in the range of from about 5 to about 30 percent by weight.

14. The roofing membrane of claim 2, wherein the bitumen is further modified by a secondary modifying polymer selected from the group consisting of styrene-isoprene styrene (“SIS”), styrene-ethylene-butylene-styrene (“SEBS”), styrene-ethylene (“SE”) and combinations thereof.

15. The roofing membrane of claim 5, wherein the modifying polymer is added to the bitumen while the bitumen is agitated in a mixer at a temperature in the range of from about 300 to about 400 degrees Fahrenheit.

16. The roofing membrane of claim 1, wherein the roofing membrane exhibits no blistering from entrained air voids after being submerged in water at about 120 degrees F. for 72 hours, then maintained at about 160 degrees F. under at least 15 in. Hg vacuum for up to 48 hours.

17. A roofing membrane, comprising:
a continuous matrix of bitumen modified by addition of a polymer, the matrix being characterized as being substantially free of voids containing entrained air;
the modifying polymer being selected from a group consisting of: styrene-butadienestyrene (“SBS”) block co-polymer, atactic polypropylene (“APP”), and a combination of SBS and APP;
the bitumen being selected from the group consisting of straight run asphalts with a rod & ball softening point in the range of from 80 to 130 degrees F.; oxidized asphalts, solvent washed asphalts, road tars, refined tars, and blends thereof;
wherein the bitumen is modified by the polymer by adding the polymer to the bitumen while the bitumen is in a molten state in a sealed mixing vessel where the bitumen is agitated at a temperature in the range of from about 300 to about 400 degrees Fahrenheit;
wherein the modified bitumen is exposed to a pressure during modification or after modification while still in a molten state of less than ambient, the pressure being at least 15 inches Hg less than ambient;
wherein a reinforcing mat of fibers is embedded in the matrix;
wherein an upper or weathering surface of the membrane is coated with a granular material;
wherein a lower or non-weathering surface of the membrane is coated with a means for preventing self-adhesion;
wherein the modifying polymer is present in the modified bitumen in the range of from about 5 to about 30 percent by weight.
wherein the bitumen is further modified by a secondary modifying polymer selected from the group consisting of styrene-isoprene styrene (“SIS”), styrene-ethylene-butylene-styrene (“SEBS”), styrene-ethylene (“SE”) and combinations thereof.

18. A process for producing a roofing membrane, comprising the steps of:
providing a bitumen being selected from the group consisting of straight run asphalts with a rod & ball softening point in the range of from 80 to 130 degrees F.; oxidized asphalts, solvent washed asphalts, road tars, refined tars, and blends thereof;
providing a modifying polymer being selected from a group consisting of: styrenebutadiene-styrene (“SBS”) block co-polymer, atactic polypropylene (“APP”), and a combination of SBS and APP;
modifying the bitumen by adding the modifying polymer to the bitumen while the bitumen is in a molten state in a sealed mixing vessel where the bitumen is agitated at a temperature in the range of from about 300 to about 400 degrees Fahrenheit;
exposing the modified bitumen to a pressure less than ambient during or after modification while still in a molten state to allow release of entrained gases; and
forming the roofing membrane from the molten modified bitumen.
